(19) United States
(12) Patent Application Publication
(10) Pub. No.: US 2013/0290837 A1
(43) Pub. Date: Oct. 31, 2013

(54) Method and Apparatus for Correcting Document Formatting Based on Source Document

(71) Applicant: James Paul Hudetz, Aurora, IL (US)

(72) Inventor: James Paul Hudetz, Aurora, IL (US)

(21) Appl. No.: 13/460,162

(22) Filed: Apr. 30, 2012

(51) Int. Cl. G06F 17/00

(52) U.S. Cl. 715/255

(57) ABSTRACT

Methods, apparatus and computer-readable medium are disclosed for reformatting documents based on a source document. In one example, a method for facilitating the formatting of content of an active document is provided. The method includes receiving style template data in response to a display of style source template indicators. A style template preview based on the style template data is displayed and style template selection data indicating a selected style source template is received. A reformatted document is generated in which the reformatted document is based on the active document and source style data from the selected style source template. A reformat preview is then displayed including a representation of the active document and a representation of the reformatted document.

### CROSS-REFERENCE TO RELATED APPLICATIONS

This application is related to co-pending utility application entitled METHOD AND APPARATUS FOR THE SELECTION AND REFORMAT OF PORTIONS OF A DOCUMENT and filed on even date herewith and having attorney docket number 43960.00.0008.

### BACKGROUND

The creation of documents is a task pervasive in many industries and businesses. The formatting of documents is a critical component of document creation that can significantly influence the readability, interpretation and communication of ideas and knowledge. The format of documents can be particularly important in fields such as the legal industry and communication with regulatory bodies that require particular document formats in communications with the regulatory body. With this in mind, tools have been created to assist in the creation and the formatting of documents.

Some examples of tools that exist to aid in the creation and formatting of documents include word processing applications such as Microsoft Word® and WordPerfect®. Additionally, templates and standardized forms also exist that can assist a user in the creation or formatting of documents. Many of these tools, however, require the intervention of administrators or other experts or require specialized knowledge to implement the advantages of the document creation aids.

A specific example of a document creation aid is the so-called Styles functionality of Microsoft Word®. The Styles functionality allows different formatting to be created and then applied to portions of a document. Microsoft Word® includes some standard styles that can be applied to documents. Additionally, customized styles can be created according to the particular needs of an individual or organization. These styles can then be applied to a document to aid in the formatting of the document. The Styles functionality, however, requires specialized knowledge to create and apply its functionality. As such, the Styles functionality is often under-utilized by individuals or is misunderstood.

Document formatting is also important in the context of formatting a document received from a third-party. As is often the case, a document is received from a third-party and needs to be reformatted either to revise the document to improve readability, to correct errors or inconsistencies, or to adhere to document formatting requirements. In this context, the document may contain any number of errors or include data, metadata, or formatting that makes the reformatting of the document difficult or at least frustrating to a non-expert individual.

Still further, other situations arise in which an organization or an individual may have access to templates or standard forms but these options are unsatisfactory. The individual may have needs or preferences that are different from the templates or standard forms provided by an organization. Often, however, the individual does not possess the expertise to create a new template or standardized form for his or her individual needs or preferences.

In still another situation, an individual may want to reformat a document for any of the reasons previously described, but is unsure of what template or standard form to use even if some templates or standard forms are provided or otherwise available. After choosing a standard form, such an individual may want to view the reformatted document before accepting the change to an existing document.

### SUMMARY

With this background in mind, one object of the present disclosure is to provide a method for the preview of documents using standard templates such that a user can more accurately choose the form of a reformatted document.

Another object of the present disclosure is to provide a method for the reformat of documents from any source document via an easy to use interface. This may include allowing a user to reformat a document using an active document.

Another object of the present disclosure is to provide a method that accurately reformats a document according to a chosen template and allows a user to view the reformatted document and remove the reformatting if desired.

Still further, an object of the present invention is to provide an interface through with any of the objectives as previously described are easily performed through a user interface or other means.

The present disclosure describes methods and apparatus for facilitating the formatting of documents and for formatting documents. In one example, a method for facilitating the formatting of content of an active document is provided. The method includes receiving style template data in response to a display of style source template indicators. A style template preview based on the style template data is displayed and style template selection data indicating a selected style source template is received. A reformatted document is generated in which the reformatted document is based on the active document and source style data from the selected style source template. A reformat preview is then displayed including a representation of the active document and a representation of the reformatted document.

In another example, the style template preview is also based on applying source style data that is extracted from a source document. The source document can be the active document in another example.

In another example, generating a reformatted document also includes assigning style identifiers to criteria maps based on the style source template format data and the active document.

In another example, the method also includes generating a list of style source templates based on source documents having source characteristics and the displayed style source template indicators are based on the list.

Related apparatus and computer-readable media are also disclosed.

### BRIEF DESCRIPTION OF THE DRAWINGS

The disclosure will be more readily understood in view of the following description when accompanied by the below figures and wherein like reference numeral represent like elements, wherein:

FIG. 1 is a block diagram generally depicting one example of a formatting system in accordance with the present disclosure.

FIG. 2 is a flowchart generally depicting one example of a method for reformatting a document in accordance with the present disclosure

FIG. 3 is a representation of one example of an interface in accordance with the present disclosure.

FIG. 4 is a representation of another example of an interface in accordance with the present disclosure.

FIG. 5 is a flowchart depicting one example of the steps included in the generation of a style mapping in accordance with the present disclosure.

### DETAILED DESCRIPTION

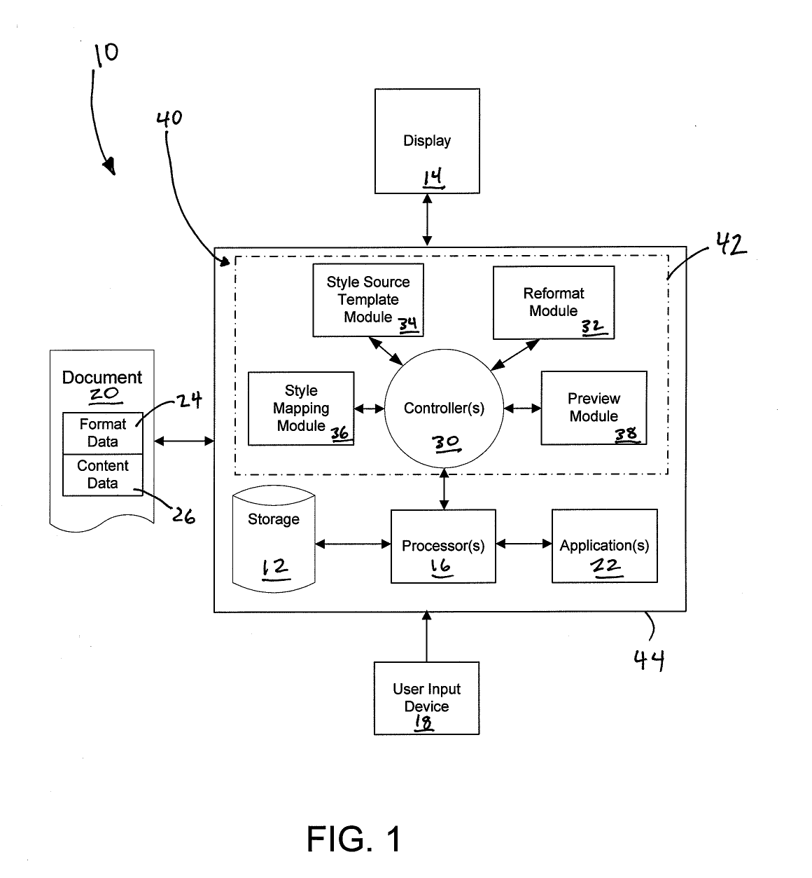

The following description of the embodiments is exemplary in nature and is in no way intended to limit the disclosure, the application of the disclosure, or uses of the subject matter contained in the disclosure. FIG. 1 illustrates a formatting system in accordance with the present disclosure. Formatting system 10, in one example, generally includes memory 42, storage 12, a processor or processors 16, a display 14, and a user input device 18. Formatting system 10 interacts with document 20. Those having skill in the art will appreciate that other components, not illustrated in FIG. 1 for ease of presentation, may be included in the formatting system 10.

As used herein, a document, such as document 20, is any electronic file containing formatted content. One example of a document is an electronic file created in a word processing application such as Microsoft Word®. Other examples of documents include, but are not limited to, spreadsheets, presentations, forms, databases, webpages, and the like. As depicted in FIG. 1, document 20 may contain content data 26 and format data 24. Content data 26 includes information regarding the text or body of a document that may include the words, language, images, or other content that a user may want to include or otherwise display via the document. Format data 24 includes other information relating to how the content data 24 will be depicted in the document. Format data 24 may include information relating to the positioning of words or images, such as justification or margins, the appearance of content, such as font or typeface, and the organization or presentation of content such as bulleting, or outlining of the content. As known in the art, the format data 24 may be represented using any of a variety of markup languages, such as Extensible Markup Language (XML). These descriptions of content data 26 and format data 24 are informational only. Content data and format data may additionally include information regarding the document as is known to one of ordinary skill in the art.

Referring back to FIG. 1, one example of a formatting system 10 of the present disclosure includes computing system 44 which may be used to implement formatting tool 40. Computing system 44 includes storage 12, processor 16, application 22, and memory 42. Processor 16 is any device capable of executing executable instructions. Processor 16 may comprise one or more of a microprocessor, micro controller, digital signal processor, co-processor, distributed processing circuitry, application specific integrated circuits or any suitable processing device known in the art or combinations thereof. Processor 16 is in communication with storage 12 and memory 42. Storage 12 and memory 42 are shown, in this example, as separate elements in FIG. 1, however, these elements may be included in a single memory device. Storage 12 and memory 42 can each be any suitable device capable of storing information such as but not limited to volatile and/or non-volatile storage devices such as random access memory (RAM), read only memory (ROM), hard drive, optical disc drive, floppy disc drive, etc. Memory devices, such as these examples and others, are well-known to those of ordinary skill in the art. In one example, the formatting methods and tools described herein are implemented as a combination of executable instructions and data stored in memory 42. Document 20, while shown separate from computing system 44 for illustration purposes in FIG. 1, can be stored in a storage device as described above such as storage 12.

Computing system 44 further includes, as seen in FIG. 1, application or applications 22. Application 22 is any tool capable of manipulating (i.e., creating, editing, storing, etc.) a document. Non-limiting examples of application 22 are Microsoft Word®, Excel®, and PowerPoint®. Memory 42, in this example, includes controller 30, preview module 38, style source template module 34, style mapping module 36, and reformat module 32, each of which may be implemented as instructions executed by processor 16. Controller 30 can be any suitable component that is able to interface with a document 20 and/or application 22. For example, such an interface may be implemented via an application programming interface (API) wherein the modules of the formatting tool 40 are able to operate through an application such as Microsoft Word®. In other embodiments, however, controller 30 may operate directly on document 20 via computing system 44. Preview module 38, style mapping module 36, style source template module 34 and reformat module 32 are shown as separate modules in FIG. 1 but can be combined in other embodiments. Additionally, the functionality of preview module 38, style mapping module 36, style source template module 34, and reformat module 32, as described further below, can be implemented independently of each other or combined as depicted in FIG. 1. Each module, individually, contains functionality and features that provide at least one advantage over the prior art as will be described.

Additionally shown in FIG. 1, coupled to computing system 44 are user input device 18 and display 14. User input device 18 is any device capable of providing input data from a user of formatting system 10. Non-limiting examples of user input device 18 are keyboards, mice, touch screens, trackballs, touchpads, and the like. Display 14 is any device capable of providing data to a user. Examples of display 14, include but are not limited to, flat screens, computer monitors, or other display mechanisms known to those of ordinary skill in the art. The connection shown in FIG. 1 between user input device 18 and display 14 and computing system 44 may be direct communication links. However, wireless or indirect connections such as connections via local or wide area networks, cellular networks, Bluetooth connections, or the like are equally contemplated between these components or other components of formatting system 10 already discussed.

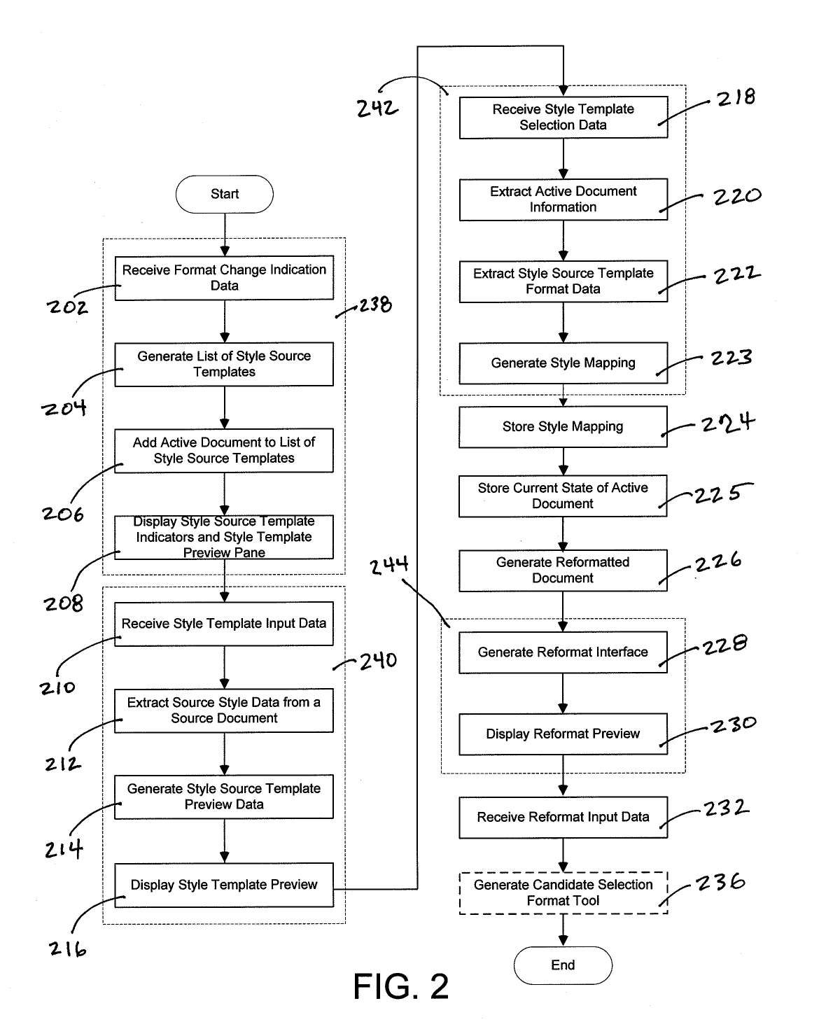

Now turning to FIG. 2, a method of reformatting the content of a document is described in accordance with one example of the present invention. It is noted that FIG. 2 is a flowchart of an overall process. However, as noted below, some of the steps add advantageous functionality or otherwise improve an already advantageous process. As such, not all of the steps must be completed in combination to result in an advantage over the prior art. Sub-sets of the steps shown in FIG. 2 can be performed individually or performed in alternate orders and combinations to provide advantages in the reformatting of documents. As described below, the operations illustrated in FIG. 2 may be implemented by computing system 44 or other similar devices.

FIG. 2 illustrates the overall process including style template list process 238, style template preview process 240, style mapping process 242, and reformat preview process 244. As discussed above, these processes need not be performed in combination and include advantages over known reformatting techniques and processing. Style template list process 238 may include steps 202 through 208 as will be further discussed below, and includes the process of generating a list of style source templates and displaying the list of style source templates to a user via an interface. In one example, this processing can be accomplished via executable instructions in the form of style source template module 34 located within memory 42 of computing system 44.

The overall process also includes style template preview process 240. Style template preview process may include steps 210 through 216 of FIG. 2 and generally includes the extraction of data from a source document and displaying a preview showing the formatting of a style source template. This process and steps 210 through 216 are described in more detail below. In one example of formatting system 10, style template preview process 240 can be accomplished via executable instructions as represented by style source template module 34 located within memory 42 of computing system 44.

Style mapping process 242 includes steps 218 through 223 and, in one example, accomplishes the task of comparing the active document with the style source template to determine how the formatting of the style source template should be applied, if at all, to the active document. This may be accomplished via the interim steps discussed in more detail below. In one example, style mapping process 242 can be accomplished via executable instructions as represented by style mapping module 36 located within memory 42 of computing system 44.

Reformat preview process 244, also shown in FIG. 2, may include steps 228 and 230. In one example, the reformat preview process 244 displays a preview of a reformatted document and a preview of the active document so that a user can decide whether to accept or reject the reformatting that is suggested by the reformatting tool. Reformat preview process 244 can be accomplished via executable instructions as represented by preview module 38 located within memory 42 of computing system 44.

The steps not included in the discussion above can additionally be implemented via executable instructions located within memory 42 of computing system 44. The executable instructions to provide the functionality of the steps may be included in one preview module 38, style mapping module 36, style source template module 34, or reformat module 32. In other examples, the executable instructions are provided in other modules not shown on FIG. 1 or organized and provided via techniques known to those of ordinary skill in the art.

In one non-limiting example of the present disclosure the overall process begins with style template list process 238 in which a list of style source templates are displayed to a user. The formatting tool receives style template input data in response to a user's selection of a style source template and a preview of the formatting that corresponds to the selected style source template is displayed during style template preview process 240. Once style template selection data is received based on a user's acceptance or selection of a style source template, the formatting of the style source template is mapped against the active document during style mapping process 242. A preview of a representation of the active document is displayed in addition to a representation of a reformatted document during reformat preview process 244. The user can then accept or reject the reformatting. The foregoing description is only used for illustration purposes and should not be seen as limiting the present disclosure.

Turning again to FIG. 2, the overall process begins with style template list process 238. The first step of style template list process 238 is step 202 wherein formatting tool 40 receives format change indication data. Format change indication data is information received that communicates to the system that reformatting of a document is desired. In one example, a user may click a button or perform a keystroke or otherwise provide information via user input device 18 that results in this step. A user can provide format change indication data within an executing application such as a button on a toolbar within Microsoft Word® or provide format indication change data via other methods such as double-clicking an icon or other methods known to one of ordinary skill in the art.

Once format change indication data is received, the next step is generating a list of style source templates 204. In this step, the formatting tool 40 determines what style source templates are available. A style source template is a file that includes information such as format data that can be used to format the content of another document. In one example, a style source template is a document created by an organization or administrator that includes standard or preferred formatting such that if the format data of the style source template is applied to other documents, the other documents will look, be arranged, or otherwise be organized according to a standard or preferred set of characteristics or requirements. Standard documents of this nature are particularly useful in the legal, regulatory, or other standardized industries. Other industries or fields, however, can benefit from the advantages of the disclosed processes and tools disclosed herein. Alternatively, a style source template can be generated from any other document (not specifically created to be a style source template) that includes formatting that is desirable to a user.

In an embodiment, the formatting tool 40 generates a list of style source templates by determining if any style source templates, as previously described, have source characteristics. Source characteristics are properties of a style source template reflecting its availability. An example of a source characteristic is whether a style source template is stored in a specified location. One way of accomplishing this step is for the tool to determine if any style source template documents are saved in particular location, as specified by a source characteristic, such as in a sub-section of storage 16 or by other ways known to one of ordinary skill in the art. Alternatively, well known file selection mechanisms, such as pull-down menus, search boxes, etc., may be used to identify available style source templates. The list generated in this step provides a summary of the available style source templates such as the file names of the style source template documents.

The next step is adding the active document to the list of style source templates 206. In the formatting tool 40, an active document can be used as a style source template. As used herein, an active document is a document that is currently open in an application. One example of an active document is a document open in Microsoft Word®. One way of performing step 206 is for the tool to determine if the active document has been committed to memory. The tool may determine if the active document has been saved to disk. This can be accomplished via interaction between the application and controller 30 in which the status of an active document can be determined. This type of interaction is well-known to one of ordinary skill in the art. In one example, if the active document has been committed to memory the active document (or its file name) is added to the list of style source documents.

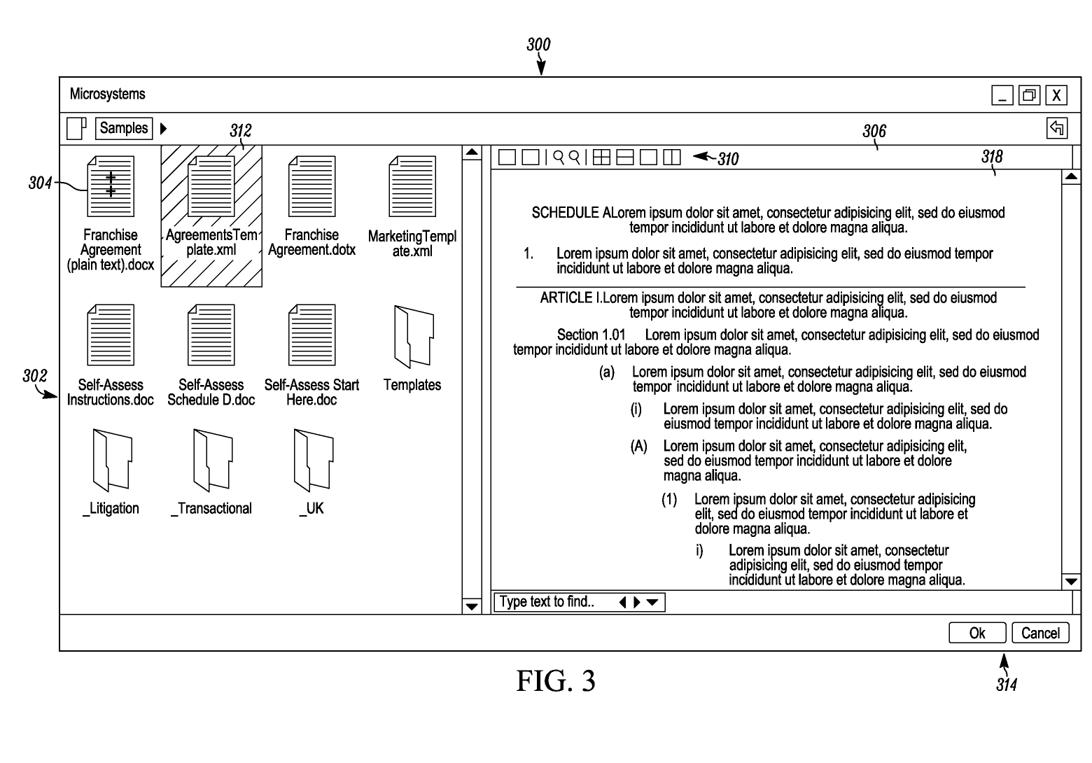

Processing continues, as shown in FIG. 2, with step 208 in which style source template indicators and a style template preview pane are displayed. FIG. 3 illustrates one example of the display of style source template indicators 302 and style template preview pane 306 in style source template interface 300. As illustrated, one method of displaying style source template indicators 302 and style template preview pane 306 is via a window on display 14 as shown. In this example, style source template indicators 302 are displayed as graphical icons including the name of the style source template. Style source template indicators, however, can be any representation of the style source templates. Other examples of possible style source template indicators include a text list, thumbnails, acronyms, or other representations. Each style source template from the list of style source templates generated in step 204 and the active document added to the list in step 206 is displayed in step 208 as a style source template indicator. The active document style source indicator 304 may include additional information or a graphical signal, as shown in FIG. 3 by the double-cross symbol, differentiating the active document style source template indicator 304 from other style source template indicators 302.

Step 208 also includes displaying style template preview pane 306. Style template preview pane 306 is a location and tool on style source template interface 300 in which a style template preview 318 is shown. Style template preview pane 306 can, in one example, initially be an empty window until a style source template indicator 302 is selected. Alternative, style template preview pane 306 may include a default style template preview 318. To achieve the display of a default style template preview or subsequent display of a style template preview, style template preview process 240 will be performed as will be discussed below. Style template preview pane may also optionally include style template preview view controls 310 and style template search tool 308. Style template view controls 310 allow a user to change different properties in which style template preview 318 is displayed. Examples of the functionality that style template preview view controls 310 can manipulate are the zoom, size, and pagination view of style template preview 318. Style template preview view controls 310 are shown as buttons in FIG. 3, however, other methods of implementing the controls can be used as would be known to one of ordinary skill in the art. Style template preview search tool 308 is also shown in FIG. 3. This tool enables a user to search style template preview 318 to locate particular content or other information in the preview. After the conclusion of step 208, the style template list process 238 concludes and style template preview process 240 begins.

As stated earlier, style template preview process 240 begin with step 210 wherein style template input data is received. Style template input data is information received by formatting tool 40 indicating a style source template to be displayed. In one example of formatting tool 40, a user may want to select a particular style source template in response to the display of style source template indicators 302 in style source template interface 300. The user, in this example, selects a particular style source template to be previewed by clicking on one of the style source template indicators 302. In response, formatting tool 40 receives style template input data at step 210 that includes information indicating the user's desire to preview the chosen style source template as a style template preview 318. In another example, formatting tool 40 may receive style template input data in the form of a default setting. An administrator or individual may have a preferred style source template and may set this preferred style source template as the default style source template in the options provided by an embodiment of formatting tool 40. With this default setting, style template input data is received at step 210 that indicates a default style template preview that will be displayed in style template preview pane 306.

After receiving style template input data at step 210, source style data is extracted from a source document at step 212. A source document is any document that is used to create a style source template. At step 210 format data is extracted from a source document in the form of source style data. Source style data is format data from the source document that can then be used to reformat another document. The format data, as described earlier, can be any information relating to the appearance, organization, or structure of the content of a document such as, but not limited to, margin information, font size and type, paragraph size, line spacing, and the like. Source style data can be extracted via any suitable method known to one of ordinary skill in the art. One such example is via accessing the extensible markup language (XML) of a document, searching for, and copying data according to a set of predefined extraction criteria. Other methods, such as but not limited to, binary data through Word object model, may be used. Once source style data is extracted, the source style data is optionally stored in storage 12.

Step 212, as described with regards to the example above, does not necessarily have to be performed each time a source template preview is displayed. In another example, in response to receiving style template input data at step 210, formatting tool 40 may determine if source style data has already been extracted from a source document. This determination may be made by accessing storage 12 and seeing if style template input data has been stored. If style format data from a source document has already been extracted in response to a selection of a particular source style template indicator, this previously extracted source style template input data is accessed and processing continues to step 214.

At step 214, style source template preview data is generated. Style source template preview data is information that enables the style template preview 318 to be displayed in style template preview pane 306. Style source template preview data, in one example, may be based on source style data extracted at step 212 and content data allowing a user to visualize the format data as it would appear when applied to the content of a document. In one example, a common portion of content data is used and is part of the style template preview data. If a common portion of content data is used, such as a standard block of text, in conjunction with different source style data, then as a user views different style template previews 318, the differences between the different style source templates are more readily apparent.

Step 214 may additionally include storing style source template preview data. In one example, style source template preview data is stored in storage 12 of computing system 44. Style source template preview data may be stored so that if the generation of source template preview data is not required each time style source template input data is received in response to a user's selection of a style source template indicator. If style source template preview data is stored, style template preview process 240 may include a step in which, prior to the extraction of source style data at step 212, formatting tool 40 determines if style source template preview data corresponding to the selected style source template indicator is stored. When style source template preview data has been previously stored, steps 212 and 214 can be skipped and the style template preview can be displayed at step 216.

At step 216 style template preview 318 is displayed. Style template preview 318 can be any representation of the style source template preview data that is then used to select a style source template. In one example, style template preview 318 is a representation of a document displaying a common block of text formatted in accordance with source style data and displayed in style template preview pane 306 as shown in FIG. 3. The example style template preview 318 shown in FIG. 3 is a representative document that can be viewed using style template preview view controls 310 and searched using style template preview search tool 308. Step 216 is the last step, in this example, of style template preview process 240.

Style template preview process 240 or at least portions of style template preview process may be repeated at this point in the overall process. Style template input data can be received additional times, source style data can be extracted from multiple source documents, style source template preview data can be generated, and multiple different style template previews can be displayed. In one example processing consistent with the present disclosure, a user may click on a first style source template indicator 302 and steps 210, 212, 214 are performed resulting in the display of a style template preview corresponding to the selected style source template indicator. Before proceeding to step 216 of the overall reformatting process, a user may want to preview a different style source template and click on a different style source template indicator. As stated above, source style data may have been previously extracted and/or style source template preview data can be stored. In these embodiments, the steps of style template preview process 240 or some sub-set of the steps shown in FIG. 2 are performed to result in a different style template preview 318 being displayed at step 216. This can continue until a style source template is found that satisfies a user's preferences. Once a satisfactory style source template is found in response to a possible iterative process associated with style template preview process 240, the overall reformatting process can continue.

Style mapping process 242 begins with step 218. Step 218 is receiving style template selection data. Style template selection data is information received that indicates a particular style source template has been chosen. Style template selection data, in one example, can be information received in response to a user's click of a button to confirm reformatting in accordance with a formatting layout displayed via a style template preview 318. FIG. 3 depicts one example in which a user can click the “OK” button of the style template selection controls 314. This action, in turn, results in the receiving of style template selection data indicating the selection. Other methods of providing and receiving style template selection data can be used, however. Some non-limiting examples may include double-clicking a style source indicator 302, entering a keystroke, providing a command, or other methods known to one of ordinary skill in the art.

Processing continues at step 220 in which information from the active document is extracted. Extraction may be accomplished via any suitable method, one example of which is a similar method discussed earlier with regards to step 212. The information extracted from the active document may include content data such as text, words, images, or other content. The information may also include format data such as direct format data, traditional style data, and document-specific format data. Direct format data, as opposed to traditional style data, is format data that is applied directly to a given text range instance. Direct format data information applies only to the range of text for which it is targeted. Traditional style data is format data applied to entire sections of a document. Traditional style data is declared once at the document level and then can be applied via reference to a portion of the document.

Referring now back to the extraction of information from the active document at step 220, the extracted information may include format data, in various types (i.e., traditional style format data or direct format data) as discussed above, and content data as well. Extracted active document information may be used at later stages of style mapping process 242 and reformat preview process 244.

The next step in style mapping process 242 is step 222 where style source template format data is extracted. In one example, style source template format data is extracted via techniques described with respect to step 212. Furthermore, if source style data was saved during or after it was extracted at step 212, the source style data may be accessed and used in place of re-extracting format data. In a second embodiment, however, the style source template is accessed and the format data contained therein is extracted using techniques previously described or known to one of ordinary skill in the art.

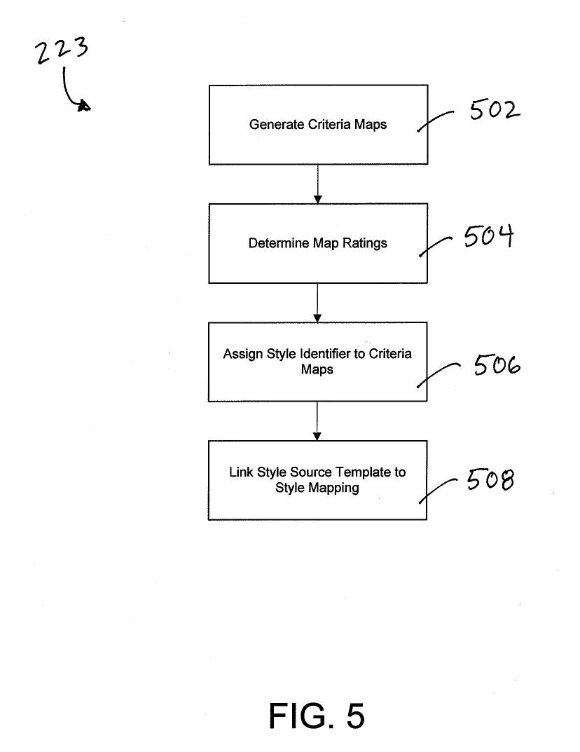

Processing continues at step 223 wherein the style mapping is generated. Step 223 consists of several sub-steps that are performed to result in a style mapping. These sub-steps of step 223 are shown in FIG. 5.

The generation of the style mapping begins with step 502 in which criteria maps constituting the style mapping are generated. A criteria map is information collected from the active document and pre-selected key attributes regarding the shape of a paragraph or portion of the active document. A criteria map is generated based on the active document information collected at step 220 and pre-selected key attributes. Some examples of key attributes include, but are not limited to, the indenting of the first line of a paragraph or portion, the style of a paragraph or portion, and the line-spacing of a paragraph or portion. In another example, the pre-selected key attributes are the number pattern (i.e., the first few characters of a paragraph or portion), the indenting of the paragraph or portion, and the alignment of the paragraph or portion. The pre-selected key attributes may be set by an administrator or at the organization level. Additionally, formatting tool 40 may include an interface such that the pre-selected key attributes can be changed according to an individual's needs. Various methods can be used to allow for the changing of pre-selected key attributes such as text-boxes, slider bars, radio buttons, command lines, key strokes and other techniques known to those of ordinary skill in the art. The pre-selected key attributes include information describing the formatting attributes to be used during assignment of formatting data from the style source template to the active document based on the shape of a paragraph or portion of the active document. The changing of the pre-selected key attributes can change the diversity of paragraphs or portions of a document that will be reformatted.

As stated, in one example, a criteria map can be based on the pre-selected key attributes and the shape of a paragraph or a portion of a document. The shape of a paragraph or portion of a document is often described by categorizing the paragraph or portion of a document. Some example categories of shapes of paragraphs or portions of a document are: a numbered portion (i.e., a portion that begins with a number or other character such as in an outline), a title portion (i.e., a line of text that describes the following text), and a body portion (i.e., a block of text). Using the categories of shapes of the paragraphs or portions of a document, criteria maps are generated at step 502 based on the pre-selected key attributes (for each shape) and the shape of the paragraph or portion such that a criteria map is generated for each paragraph or portion of the active document.

Sub-step 504 next includes the determination of map ratings. In one example, map ratings are determined based on the extracted style source template format data (at step 222) as compared against each criteria map. For example, information regarding traditional style data is extracted from the style source template during the processing at step 222. The traditional style data includes information regarding the characteristics of each individual style included in the style source template. Some example characteristics of an individual style can be, but are not limited to, line spacing, numbering, and indenting. In one example processing of step 222, the information regarding the characteristics of a particular style extracted from a style source template are compared against the criteria map to result in a map rating that reflects how closely the characteristics (i.e., the line spacing, margins, and indenting, in this example) of the particular style match the criteria map. For example, weighted point values can be totaled for each characteristic of an extracted style that matches a corresponding characteristic of the map rating where different weights of points reflect the relative importance of a given characteristic in characterizing a given map rating. Each of the styles extracted from the style source template, in this example, are compared against the various criteria maps to generate map ratings. At the end of this sub-step multiple map ratings have been generated for each criteria map versus the various styles extracted from a style source template.

At sub-step 506, a style identifier is assigned to each criteria map. The various map ratings, for a given criteria map generated at step 504, are then compared and the style with the highest map rating (reflecting the closest match) is assigned to that particular criteria map by a style identifier. Map ratings can be compared via any suitable method and, as noted above, the map ratings generated at step 504 are given a numerical value representing the amount of attributes that match between the criteria map and the style characteristics. These numerical values can then be compared against one another. Other suitable techniques for the comparison of map ratings, as known to those of ordinary skill in the art, can be used. Once the highest map rating is determined, a style identifier is assigned to each criteria map reflecting this information. A style identifier is data referencing the style (with the highest map rating) that should be applied to the criteria map. Any suitable technique can be used to assign a style identifier as is known to one of ordinary skill in the art. In this example, a style identifier is added for each match of a given criteria map according to the determined map ratings. At the end of this processing, the result is a style mapping that includes information that describes the format data from the style source template (or which style from the style source template, in this example) that should be applied to a given criteria map.

Processing continues with sub-step 508 in which the style source template is linked to the style mapping. In one example, the style source template is linked to the style mapping with a reference to the file name of the style source template or other technique known to one of ordinary skill in the art. The linking permits the retrieval of the appropriate style source template format data that will be needed during reformatting of an active document according to the style mapping.

At this point, the processing of formatting tool 40 may continue as shown in FIG. 2. Step 224 is the storing of the style mapping. The style mapping created according to the previously described steps, in one example, is stored according to suitable techniques, such as but not limited to, the saving of the style mapping in storage 12 of computing system 44.

Next, at step 225 the current state of the active document is stored. The current state of the active document includes the format data and content data that is needed to display the active document as it appears before any reformatting is performed. In one example, the active document is serialized, according to known techniques, and is stored in storage 12 of computing system 44. Other methods of storing the active document, as known to one of ordinary skill in the art, may also be used.

At step 226, the reformatted document is generated. The reformatted document is generated based on the content of the active document, the style mapping, and the style source template format data. To accomplish this step, in one example, the style source template format data, such as the style information, from the style source template linked to the style mapping, in step 508, is loaded into the active document. Each paragraph or portion of the active document is then analyzed for criteria similar to the criteria discussed above with respect to the generation of the criteria maps at step 502. As the criteria for each paragraph or portion of the active document is determined, they are compared against the criteria in the criteria maps. Where a successful comparison of criteria between the paragraph or portion of the active document and the criteria maps is found, the style source template format data, or style in one example, identified by the style identifier is applied to that paragraph or portion of the document. Each paragraph or portion of the active document is analyzed in this manner. As a result of this processing, style source template format data from the style source template is applied to the active document to result in a reformatted document.

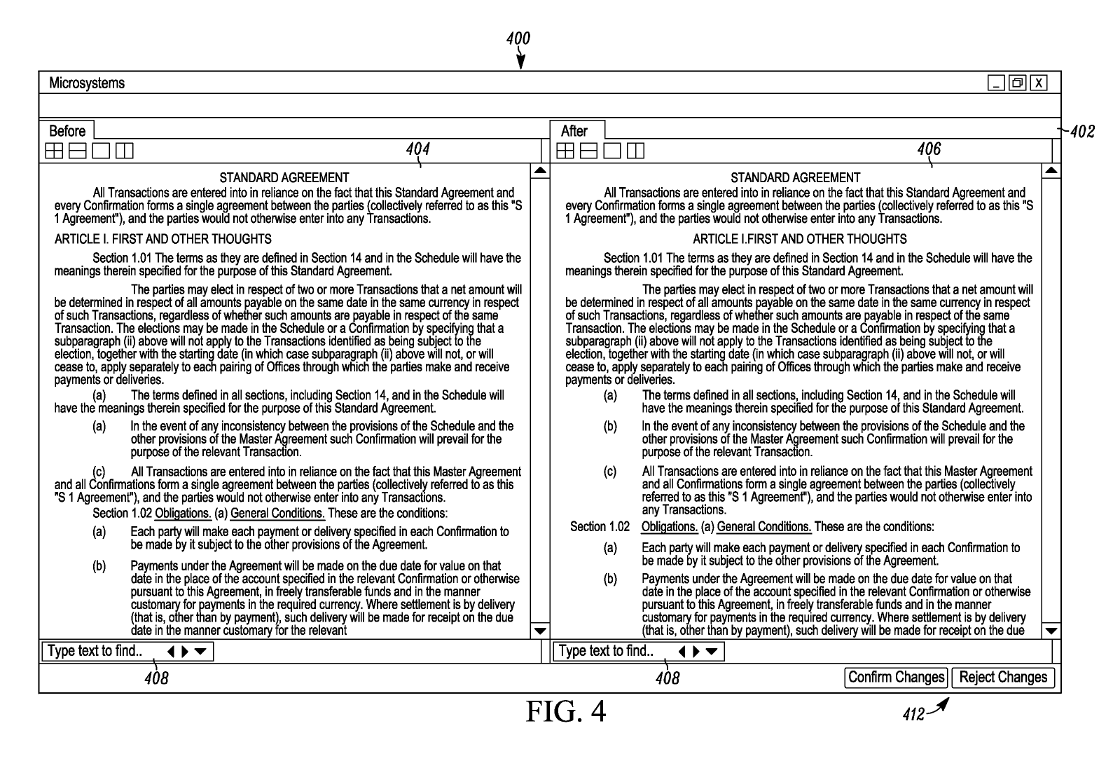

Next, reformat preview process 244 begins with step 228. At step 228, reformat interface 400 is generated. Reformat interface 400 is a tool that allows the representation of the reformatted document to be displayed and accepted or rejected. Reformat interface 400 may also allow the representation of the reformatted document to be manipulated. One example of reformat interface 400 is shown in FIG. 4. As illustrated, reformat interface 400 may be a window displayed on display 14. In this example, reformat interface 400 includes a representation of the active document 404, a representation of the reformatted document 406, reformat preview controls 410, reformat preview search tool 408, and reformat confirmation controls 412. Representation of the active document 404 is a view of the active document including its content and current or original formatting. Reformat preview view controls 410 allow a user to manipulate the representation of the active document by changing page views, changing the zoom and may additionally include other view controls known to one of ordinary skill in the art. Representation of the active document 404 can also be accessed and searched via reformat preview search tool 408. Reformat search tool 408 allows the searching of the representation of the active document using techniques readily known in the art.

Reformat interface also includes a representation of the reformatted document 406. Reformat preview view controls 410 may also be provided in addition to reformat preview search tool 408 to provide greater control over the previews as described. Reformat interface 400, in this example, also includes reformat confirmation controls 412. Reformat confirmation controls 412 are elements of reformat interface 400 that allow reformatting of the active document to proceed in accordance with the representation of the reformatted document. As shown, reformat confirmation controls 412 can be buttons that provide an indication as to whether reformatting of the active document should be accepted (i.e., permanently made to the active document) or rejected. Other methods and interfaces can be provided that allow the reformatting process to continue as are known to one of ordinary skill in the art. Some examples include keystrokes, command lines or an indication with a mouse and a pointer provided in reformat interface 400.

Next, the reformat preview is displayed at step 230. In this step the representation of the reformatted document is displayed on display 14. The reformatted document can be displayed by serializing the reformatted document, created in step 226, converting the serialized state into a data format and displaying the reformatted document in reformat preview pane 402 of reformat interface 400. Other methods, known to one of ordinary skill in the art, may additionally be used. In one embodiment of reformat interface 400, only the representation of the reformatted document is displayed. In another example, such as the one shown in FIG. 4, the reformat preview includes a representation of the active document 404 and a representation of the reformatted document 406. The representation of the active document can be displayed by any suitable technique known to one of ordinary skill in the art. One example method is by converting the serialized current state data of the active document saved at step 225 into a data format and displaying the representation of the active document in reformat preview pane 402. The reformat preview illustrated in FIG. 4 allows a user to view both the representation of the active document 404 and the representation of the reformatted document 406 simultaneously. In this configuration, the changes to the active document, if reformatting is accepted, are more discernible to the user. For example, as seen in FIG. 4, the reformatting of ARTICLE I and the reformatting of Section 1.01(a) and Section 1.01(c) are readily apparent. If the user wants to continue with the reformatting, the user will confirm the choice by interaction with reformat confirmation controls 412.

Processing continues to steps 232. In step 232, reformat input data is received. Reformat input data is data that indicates a choice to confirm or reject the reformat of the active document. In one example, reformat input data is received in response to a user's interaction with reformat confirmation controls 412 of reformat interface 400. If the reformat input data provides information that reformatting of the active document is accepted, the reformatted document previously generated can be committed to the active document. In one example, the reformatted document is saved to storage 12. If the reformat input data provides information that reformatting of the active document is to be rejected, the reformatting of the document is removed and the active document is returned or left in its original condition.

At the conclusion of step 232, a reformatted document has been generated that includes a format that reflects the formatting of the source document. At this point, the reformatting process may optionally include a process in which individual portions of the reformatted document may be reformatted individually or separately from each other. The steps of such a process can be implemented as described in the disclosure contained in the related patent application, entitled METHOD AND APPARATUS FOR THE SELECTION AND REFORMAT OF PORTIONS OF A DOCUMENT.

The above description of the present disclosure should not be interpreted such that the steps of the process discussed above are required to be performed in the order discussed unless specifically stated. The steps discussed above should also not be interpreted as required or as a whole to provide the advantages of the present disclosure. The above description and the examples described herein have been presented for the purposes of illustration and description only and not by way of limitation. It is therefore contemplated that the present disclosure cover any and all modification, variation or equivalents that fall within the spirit and scope of the basic underlying principles disclosed above and claimed herein.

1. A method of formatting content of an active document comprising:
receiving style template data in response to a display of style source template indicators;
displaying a style template preview based on the style template data;
receiving style template selection data indicating a selected style source template;
generating a reformatted document based on the active document and style source template format data from the selected style source template; and
displaying a reformat preview including a representation of the active document and a representation of the reformatted document.

2. The method of claim 1 wherein displaying the style template preview is further based on applying source style data extracted from a source document.

3. The method of claim 2 wherein the source document is the active document.

4. The method of claim 1 wherein generating a reformatted document comprises:
assigning at least one style identifier to at least one criteria map based on the style source template format data and the active document.

5. The method of claim 1 further comprising:
generating a list of style source templates based on source documents having source characteristics; and
wherein the display of style source template indicators is based on the list.

6. The method of claim 1 wherein the style template data is received from a user input device.

7. An apparatus for formatting content of an active document comprising:
at least one processing device; and
memory operatively connected to the at least one processing device, the memory comprising executable instructions that when executed by the at least one processing device cause the at least one processing device to:
receive style template data in response to a display of style source template indicators;
display a style template preview based on the style template data;
receive style template selection data indicating a selected style source template;
generate a reformatted document based on the active document and style source template format data from the selected style source template; and
display a reformat preview including a representation of the active document and a representation of the reformatted document.

8. The apparatus of claim 7, wherein the executable instructions, when executed by the at least one processing device, cause the at least one processing device to display the style template preview further based on applying source style data extracted from a source document

9. The apparatus of claim 8 wherein the source document is the active document.

10. The apparatus of claim 7, wherein the executable instructions, when executed by the at least one processing device, cause the at least one processing device to generate a reformatted document by assigning at least one style identifier to at least one criteria map based on the style source template format data and the active document.

11. The apparatus of claim 7, wherein the executable instructions, when executed by the at least one processing device, cause the at least one processing device to receive the style template data from a user input device.

12. A non-transitory computer readable medium comprising executable instructions that when executed by at least one processing device cause the at least one processing device to:
receive style template data in response to a display of style source template indicators;
display a style template preview based on the style template data;
receive style template selection data indicating a selected style source template;
generate a reformatted document based on the active document and style source template format data from the selected style source template; and
display a reformat preview including a representation of the active document and a representation of the reformatted document.

13. The non-transitory computer readable medium of claim 12, wherein the executable instructions, when executed by the at least one processing device, cause the at least one processing device to display the style template preview further based on applying source style data extracted from a source document

14. The non-transitory computer readable medium of claim 13 wherein the source document is the active document.

15. The non-transitory computer readable medium of claim 12, wherein the executable instructions, when executed by the at least one processing device, cause the at least one processing device to assign at least one style identifier to at least one criteria map based on the style source template format data and the active document.

16. The non-transitory computer readable medium of claim 12, wherein the executable instructions, when executed by the at least one processing device, cause the at least one processing device to receive the style template data from a user input device.
